(19) United States
(12) Patent Application Publication
(10) Pub. No.: US 2021/0175483 A1
(43) Pub. Date: Jun. 10, 2021

(54) CERAMIC SEPARATOR AND METHOD FOR MANUFACTURING THEREOF

(71) Applicant: BenQ Materials Corporation, Taoyuan City (TW)

(72) Inventors: Kai-Wei CHENG, Taoyuan City (TW); Mei-Sia LYU, Taoyuan City (TW); Wei-Ting YEH, Taoyuan City (TW)

(21) Appl. No.: 16/867,545

(22) Filed: May 5, 2020

(30) Foreign Application Priority Data
Dec. 5, 2019 (TW) 108144573

(51) Int. Cl. H01M 2/16; H01M 2/14

(52) U.S. Cl. CPC H01M 2/1686; H01M 2/145; H01M 2/166; H01M 2/1653

(57) ABSTRACT

The present disclosure relates to a ceramic separator. The ceramic separator comprises a porous polyolefin substrate and a ceramic layer on the at least one surface of the porous polyolefin substrate. The ceramic layer comprises polydopamine-surface-decorated inorganic particles and a water-based binder. In addition to the necessary physical properties of common separators, the ceramic separator has excellent wettability and rate of absorption so as to improve the capacity and stability of batteries at a high battery discharge rate.

### CROSS-REFERENCE TO RELATED APPLICATION

This application claims priority to Taiwan Application Serial Number 108144573, filed Dec. 5, 2019, which is herein incorporated by reference in its entirety.

### BACKGROUND

### Field of Invention

The invention relates to a ceramic separator, and more particularly to a ceramic separator including polydopamine-surface-decorated inorganic particles and a method for manufacturing the same.

### Description of Related Art

Separator is a polymer membrane applied to a lithium-ion battery, which is sandwiched between the anode and the cathode to avoid the internal short circuit due to the physical contact between the two electrodes. At the same time, the microporous of the separator allows free ions in the electrolyte to pass through between the two electrodes, making the battery generate electrical current.

The traditional separator is usually made from polyolefin. Although the polyolefin material can provide sufficient tensile strength and chemical stability at normal temperature, a large thermal shrinkage will occur at high temperatures and cause the internal short circuit. In addition, polyolefin is a hydrophobic material, so it has a poor affinity for high-polarity electrolytes, making the separator unable to absorb the electrolyte quickly, and unable to effectively hold the electrolyte in the microporous, which will greatly increase the internal resistance and reduce the performance of the battery.

In the state of the art, a ceramic separator coated with an inorganic particle layer on a porous polyolefin substrate is proposed. The high thermal stability of the inorganic particles can provide the separator high heat resistance and lower thermal shrinkage, and the chance of internal short circuit of the battery therefore can be reduced. In addition, the hydrophilicity of the inorganic particles can thereof provide the hydrophilicity to the hydrophobic surface of the polyolefin material and enhance the affinity with the polar electrolyte, and thus, the charge-discharge performance of the battery can be improved. However, the polyolefin substrate is hydrophobic and the inorganic particles are hydrophilic, the uniformity and compatibility of inorganic particles layer that coated on the polyolefin substrate are important.

It has been proposed the application of dopamine in the ceramic separator. For example, a dopamine layer on a substrate before coating a ceramic layer, or dipping a ceramic separator in a dopamine monomer solution in order to form polydopamine in-situ on the surface, or using dopamine as a binder of the ceramic slurry or as an additive mixing with the ceramic slurry to coat on the substrate. Although these proposals can enhance the adhesion of inorganic particles, all of the manufacturing processes need curing step, and it increases the complication of the manufacturing process and can't be performed in continuous process.

### SUMMARY

In view of the foregoing problems, the present invention is to provide a ceramic separator and a method for manufacturing the same. The ceramic separator of the present invention provides the necessary physical properties of common separators, also provide good wettability and liquid absorption rate, and enhances the discharge capacity and stability of the battery at a high discharge rate.

One aspect of the present invention is to provide a ceramic separator comprising a polyolefin porous substrate; and a ceramic layer coated on at least one surface of the porous polyolefin substrate, wherein the ceramic layer comprises polydopamine-surface-decorated inorganic particles and a water-based binder, and the polydopamine-surface-decorated inorganic particles are surface-decorated with 0.06 to 1.2 parts by weight of polydopamine relative to 100 parts by weight of inorganic particles.

In an embodiment of the present invention, the porous polyolefin membrane is a single-layer or a multi-layer membrane of polyethylene or polypropylene, or a composite multi-layer membrane of polyethylene and polypropylene.

The inorganic particles used in the present invention are surface decorated with polydopamine, wherein these inorganic particles are surface decorated with a polydopamine solution before being mixed into the binder, wherein the polydopamine is in an amount of 0.06 to 1.2 parts by weight, and preferably in the range of 0.12 to 0.96 parts by weight per 100 parts by weight of the inorganic particles.

In an embodiment of the present invention, the inorganic particles are at least one selected from the group consisting of Mg(OH)₂, BaSO₄, BaTiO₃, Pb(Zr,Ti)O₃ (PZT), Pb₁₋ₓLaₓZr_{1-y}, Zr, Ti_{y}O₃ (PLZT, wherein 0<x<1 and 0<y<1), Pb(Mg_{1/3}Nb_{2/3})O₃—PbTiO₃ (PMN-PT), HfO₂, SrTiO₃, SnO₂, CeO₂, MgO, NiO, CaO, ZnO, ZrO₂, SiO₂, Y₂O₃, Al₂O₃, Boehmite (AlOOH), SiC, TiO₂, and the combination thereof. In an embodiment of the present invention, the median diameter (D₅₀) of the inorganic particles is in the range between 0.1 μm and 10 μm and preferably in the range between 0.1 μm and 5 μm, and the specific surface area of the inorganic particles is in the range between 2 m²/g and 100 m²/g and preferably in the range between 2 m²/g and 50 m²/g, and more preferably in the range between 2 m²/g and 30 m²/g.

In an embodiment of the present invention, the water-based binder is at least one selected from the group consisting of styrene butadiene rubber (SBR), polyethyl acrylate, polybutyl methacrylate, and the combination thereof.

In an embodiment of the present invention, the thickness of the ceramic layer of the ceramic separator is in the range between 1 μm and 25 μm and preferably in the range between 2 μm and 16 μm, and more preferably in the range between 3 μm and 10 μm.

Another aspect of the present invention is to provide a method for manufacturing the aforementioned ceramic separator, which comprises providing a polydopamine solution and adding a plurality of inorganic particles to the polydopamine solution to form an polydopamine-surface-decorated inorganic particles slurry, providing a water-based binder solution, mixing the polydopamine-surface-decorated inorganic particles slurry with the water-based binder solution to form a ceramic composite slurry, and coating the ceramic composite slurry on a porous polyolefin substrate to form a ceramic separator with a ceramic layer.

In an embodiment of the manufacturing method of the present invention, the polydopamine solution is obtained by polymerizing dopamine in an alkaline environment, and the concentration of the polydopamine solution is between 500 ppm and 10,000 ppm and preferably between 1,000 ppm and 8,000 ppm.

In an embodiment of the manufacturing method of the present invention, the ceramic layer comprises 80 to 99 parts by weight of polydopamine-surface-decorated inorganic particles and 1 to 20 parts by weight of water-based binder, and preferably comprises 85 to 95 parts by weight of polydopamine-surface-decorated inorganic particles and 5 to 15 parts by weight of water-based binder.

The inorganic particles used in the manufacturing method of the ceramic separator of the present invention are surface-decorated with polydopamine, and directly mixed with a binder and to be coated on a porous substrate, to obtain the ceramic separator of the present invention after the coated substrate is dried. Therefore, the present method for manufacturing can be performed in continuous process.

### DETAILED DESCRIPTION

These and other aspects of the invention will become apparent from the following description of the presently preferred embodiments. The detailed description is merely illustrative of the invention and does not limit the scope of the invention, which is defined by the appended claims and equivalents thereof. As would be obvious to one skilled in the art, many variations and modifications of the invention may be affected without departing from the spirit and scope of the novel concepts of the disclosure.

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

In the following description, numerous specific details are described in detail in order to enable the reader to fully understand the following examples. However, embodiments of the present invention may be practiced in case no such specific details.

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

The present invention is to provide a ceramic separator and a method for manufacturing the same. The ceramic separator of the present invention has the necessary physical properties of common separators, also has good wettability and liquid absorption rate, and improves the discharge capacity and stability of the battery at a high discharge rate.

The present invention is to provide a ceramic separator comprising a polyolefin porous substrate; and a ceramic layer coated on at least one surface of the porous polyolefin substrate, wherein the ceramic layer comprises polydopamine-surface-decorated inorganic particles and a water-based binder, and the polydopamine-surface-decorated inorganic particles are surface-decorated with 0.06 to 1.2 parts by weight of polydopamine and preferably with 0.12 to 0.96 parts by weight of polydopamine relative to 100 parts by weight of inorganic particles.

The substrate suitable for the ceramic separator of the present invention may be a single-layer or multi-layer porous membrane containing polyolefin, polyester, or polyamide. In an embodiment of the present invention, the porous substrate may be a single-layer polyethylene (PE), a single-layer polypropylene (PP), a two-layer polyethylene/polypropylene (PE/PP), or a three-layer polypropylene/polyethylene/polypropylene (PP/PE/PP) and other polyolefin porous substrates. In an embodiment of the present invention, the thickness of the porous substrate is between 4 μm and 35 μm, preferably between 5 μm and 30 μm, and porosity thereof is between about 30% and 80%.

The polydopamine-surface-decorated inorganic particles used in the ceramic layer of the present invention are surface-decorated with a polydopamine aqueous solution. Before the inorganic particles are mixed with a water-based binder, the inorganic particles are treated with polydopamine for the surface decoration; the hydrophilicity of surface of decorated inorganic particles can be enhanced and thus to raise the wettability and liquid absorption rate of the ceramic polyolefin separator coated with the surface-decorated inorganic particles.

In the present invention, the polydopamine-surface-decorated inorganic particles can be obtained by mixing inorganic particles with a polydopamine aqueous solution, wherein the polydopamine aqueous solution is prepared by polymerizing dopamine in an alkaline environment, and the concentration of the polydopamine solution is between 500 ppm and 10,000 ppm and preferably between 1,000 ppm and 8,000 ppm, and the polydopamine is used in an amount of 0.06 to 1.2 parts by weight of polydopamine relative to100 parts by weight of inorganic particles.

In the embodiments of the present invention, the suitable inorganic particles used as the ceramic separator of the present invention are those commonly known to be used in the field of separators, such as but not limiting to those particles having good tensile strength, high electrochemical stability, and good wettability to electrolyte. In an embodiment of the present invention, the inorganic particles are at least one selected from the group consisting of Mg(OH)₂, BaSO₄, BaTiO₃, Pb(Zr,Ti)O₃ (PZT), Pb₁₋ₓLaₓZr_{1-y}, Zr, Ti_{y}O₃ (PLZT, wherein 0<x<1 and 0<y<1), Pb(Mg_{1/3}Nb_{2/3})O₃—PbTiO₃ (PMN-PT), HfO₂, SrTiO₃, SnO₂, CeO₂, MgO, NiO, CaO, ZnO, ZrO₂, SiO₂, Y₂O₃, Al₂O₃, Boehmite (AlOOH), SiC, TiO₂, and the combination thereof. In an embodiment of the present invention, the median diameter (D50) of the inorganic particles is in the range between 0.1 μm and 10 μm and preferably in the range between 0.1 μm and 5 μm, and the specific surface area of the inorganic particles is in the range between 2 m²/g and 100 m²/g and preferably in the range between 2 m²/g and 50 m²/g, and more preferably in the range between 2 m²/g and 30 m²/g.

In an embodiment of the present invention, the ceramic layer comprises 80 to 99 parts by weight, and preferably comprises 85 to 95 parts by weight of polydopamine-surface-decorated inorganic particles.

The binder suitable for the ceramic separator of the present invention is an water-based binder that is stable to the electrolyte of the battery and can bind inorganic particles to the porous substrate. In an embodiment of the present invention, the water-based binder is at least one selected from the group consisting of styrene butadiene rubber (SBR), polyethyl acrylate, polybutyl methacrylate, and the combination thereof. In an embodiment of the present invention, the ceramic layer comprises 1 to 20 parts by weight, and preferably comprises 5 to 15 parts by weight of water-based binder.

In an embodiment of the present invention, the thickness of the ceramic layer of the ceramic separator is in the range between 1 μm and 25 μm and preferably in the range between 2 μm and 16 μm, and more preferably in the range between 3 μm and 10 μm.

Another aspect of the present invention is to provide a method for manufacturing the aforementioned ceramic separator, which comprises providing a polydopamine solution and adding inorganic particles to the polydopamine solution to form an polydopamine-surface-decorated inorganic particles slurry, providing a water-based binder solution, mixing the polydopamine-surface-decorated inorganic particles slurry with the water-based binder solution to form a ceramic composite slurry, and coating the ceramic composite slurry on a porous polyolefin substrate to form a ceramic separator with a ceramic layer.

In the manufacturing method of the present invention, the polydopamine solution is obtained by polymerizing dopamine in an alkaline environment. In an embodiment of the present invention, the dopamine monomer aqueous solution is adjusted to an alkaline environment with sodium bicarbonate to polymerize to form a polydopamine aqueous solution. In an embodiment of the manufacturing method of the present invention, the concentration of the polydopamine solution is between 500 ppm and 10,000 ppm and preferably between 1,000 ppm and 8,000 ppm.

In the manufacturing method of the present invention, the inorganic particles are added to the polydopamine aqueous solution and mixed thorough, so that the surface of the inorganic particles are decorated. In one embodiment of the present invention, the polydopamine-surface-decorated inorganic particles are surface-decorated with 0.06 to 1.2 parts by weight and preferably with 0.12 to 0.96 parts by weight of polydopamine relative to 100 parts by weight of inorganic particles.

In the manufacturing method of the present invention, an appropriate amount of a water-based dispersing agent may be further added to the inorganic particles slurry to more uniformly disperse the inorganic particles in the polypolyamine solution. In an embodiment of the present invention, the water-based dispersant is at least one selected from the group consisting of polyethylene glycol, potassium polyacrylate, sodium polyacrylate, ammonium polyacrylate, polyacrylate, and the combination thereof. In an embodiment of the present invention, the amount of the water-based dispersant is between 0.1% by weight (wt %) and 5 wt %, and preferably between 0.1 wt % and 3 wt %, and more preferably between 0.1 wt % and 2 wt %.

The water-based binder suitable for the manufacturing method of the present invention is at least one selected from the group consisting of styrene-butadiene rubber (SBR), polyethyl acrylate, polybutyl methacrylate, and a combination thereof, preferably from polyacrylate, polybutyl methacrylate, styrene-butadiene rubber (SBR), and a combination thereof.

In an embodiment of the present invention, an appropriate amount of a thickening agent and/or a water-based wetting agent may be further added to the water-based binder to increase the processability of the solution. In an embodiment of the present invention, the thickener may be a polymer emulsion thickener, and preferably is at least one selected from the group consisting of carboxymethyl cellulose, polymethacrylic emulsion, polyacrylic emulsion, and a combination thereof. In an embodiment of the present invention, the water-based agent is at least one selected from the group consisting of polyether-modified polysiloxane, polyether-modified polydimethylsiloxane, polyhydric alcohol surfactant, and a combination thereof. In an embodiment of the present invention, the amount of the thickener used is preferably between 1 wt % and 10 wt %, and more preferably between 2 wt % and 8 wt %, particularly between 0.1 wt % and 2 wt %. In an embodiment of the present invention, the amount of the water-based wetting agent is preferably between 1 wt % and 15 wt %, and more preferably between 2 wt % and 12 wt %.

In the manufacturing method of the present invention, a ceramic composite slurry is coated on at least a surface of the porous substrate and the ceramic separator can be formed after the coated substrate is dried.

The present invention will be explained in further detail with reference to the examples. However, the present invention is not limited to these examples.

### Example 1

1 g of dopamine monomer was added into 1000 ml of deionized water, and then 8.4 g of sodium bicarbonate was added to adjust the solution to alkaline (pH=8.7), and the solution was continuously stirred at 25° C. for 16 hours to obtain a polydopamine aqueous solution with concentration of 1000 ppm.

In 48 g of polydopamine aqueous solution, 40 g of boehmite (AOH40, available from Nabaltec AG, Germany) with a median particle size (D50) 2.7 μm and specific surface area 3.5 m²/g and 0.2 g of sodium polyacrylate aqueous dispersant (Dispex 4140, available from BASF, Germany) were added. After 4 hours of thorough mixing, a polydopamine-surface-decorated inorganic particles slurry was obtained.

8 g of deionized water, 0.08 g of sodium carboxymethyl cellulose, 3.6 g of styrene-butadiene rubber, and 0.1 g of an aqueous wetting agent (BYK349, available from BYK, Germany) were thoroughly mixed and dispersed for 25 hours to obtain a water-based binder solution.

The water-based binder solution was added to the polydopamine-surface-decorated inorganic particles slurry, and stirred at a slow speed for 4 hours to prepare a ceramic composite slurry.

The ceramic composite slurry was coated on the surface of a PP/PE/PP porous substrate with a thickness of 16 μm, and then dried in an oven at 80° C. for 5 minutes to obtain a ceramic layer with a thickness of about 5 μm on the surface, and the total thickness of the ceramic separator was measured 20.9 μm.

The Gurley, tensile strength, peeling force, wettability, liquid absorption rate and discharge performance at different C rates of the obtained ceramic separator were determined in accordance with the measurement described hereinafter. The results were shown in table 1 and table 2.

### Example 2

3 g of dopamine monomer was added into 1000 ml of deionized water, and then 8.4 g of sodium bicarbonate was added to adjust the solution to alkaline (pH=8.5), and the solution was continuously stirred at 25° C. for 16 hours to obtain a polydopamine aqueous solution with concentration of 3000 ppm.

In 48 g of polydopamine aqueous solution, 40 g of boehmite (AOH40, available from Nabaltec AG, Germany) with a median particle size (D50) 2.7 μm and specific surface area 3.5 m²/g and 0.1 g of sodium polyacrylate aqueous dispersant (Dispex 4140, available from BASF, Germany) were added. After 4 hours of thorough mixing, a polydopamine-surface-decorated inorganic particles slurry was obtained.

8 g of deionized water, 0.08 g of sodium carboxymethyl cellulose, 3.6 g of styrene-butadiene rubber, and 0.1 g of an aqueous wetting agent (BYK349, available from BYK, Germany) were thoroughly mixed and dispersed for 25 hours to obtain a water-based binder solution.

The water-based binder solution was added to the polydopamine-surface-decorated inorganic particles slurry, and stirred at a slow speed for 4 hours to prepare a ceramic composite slurry.

The ceramic composite slurry was coated on the surface of a PP/PE/PP porous substrate with a thickness of 16 μm, and then dried in an oven at 80° C. for 5 minutes to obtain a ceramic layer with a thickness of about 5 μm on the surface, and the total thickness of the ceramic separator was measured 20.8 μm.

The Gurley, tensile strength, peeling force, wettability and liquid absorption rate of the obtained ceramic separator were determined in accordance with the measurement described hereinafter. The results were shown in table 1.

### Example 3

6 g of dopamine monomer was added into 1000 ml of deionized water, and then 8.4 g of sodium bicarbonate was added to adjust the solution to alkaline (pH=8.6), and the solution was continuously stirred at 25° C. for 18 hours to obtain a polydopamine aqueous solution with concentration of 6000 ppm.

In 8 g of polydopamine aqueous solution, 40 g of boehmite (AOH40, available from Nabaltec AG, Germany) with a median particle size (D50) 2.7 μm and specific surface area 3.5 m²/g and 0.1 g of sodium polyacrylate aqueous dispersant (Dispex 4140, available from BASF, Germany) were added. After 4 hours of thorough mixing, a polydopamine-surface-decorated inorganic particles slurry was obtained.

8 g of deionized water, 0.08 g of sodium carboxymethyl cellulose, 3.6 g of styrene-butadiene rubber, and 0.1 g of an aqueous wetting agent (BYK349, available from BYK, Germany) were thoroughly mixed and dispersed for 24.5 hours to obtain a water-based binder solution.

The water-based binder solution was added to the polydopamine-surface-decorated inorganic particles slurry, and stirred at a slow speed for 4 hours to prepare a ceramic composite slurry.

The ceramic composite slurry was coated on the surface of a PP/PE/PP porous substrate with a thickness of 16 μm, and then dried in an oven at 80° C. for 5 minutes to obtain a ceramic layer with a thickness of about 5 μm on the surface, and the total thickness of the ceramic separator was measured 21.1 μm.

The Gurley, tensile strength, peeling force, wettability and liquid absorption rate of the obtained ceramic separator were determined in accordance with the measurement described hereinafter. The results were shown in table 1.

### Comparative Example

In 48 g of deionized water, 40 g of boehmite (AOH40, available from Nabaltec AG, Germany) with a median particle size (D50) 2.7 μm and specific surface area 3.5 m²/g and 0.2 g of sodium polyacrylate aqueous dispersant (Dispex 4140, available from BASF, Germany) were added. After 4 hours of thorough mixing, an inorganic particles slurry was obtained.

8 g of deionized water, 0.08 g of sodium carboxymethyl cellulose, 3.6 g of styrene-butadiene rubber, and 0.1 g of an aqueous wetting agent (BYK349, available from BYK, Germany) were thoroughly mixed and dispersed for 12 hours to obtain a water-based binder solution.

The water-based binder solution was added to the inorganic particles slurry, and stirred at a slow speed for 4 hours to prepare a ceramic composite slurry.

The ceramic composite slurry was coated on the surface of a PP/PE/PP porous substrate with a thickness of 16 μm, and then dried in an oven at 80° C. for 5 minutes to obtain a ceramic layer with a thickness of about 5 μm on the surface, and the total thickness of the ceramic separator was measured 20.9 μm.

The Gurley, tensile strength, peeling force, wettability, liquid absorption rate and discharge performance at different C rates of the obtained ceramic separator were determined in accordance with the measurement described hereinafter. The results were shown in table 1 and table 2.

Measurement of Gurley

The Gurley, which is the time required for 100 c.c. air to pass through the separator, was measured by the Gurley air permeability tester according to ASTM D-726, and the sample size used for measurements was 1 square inch.

Measurement of Tensile Strength

The tensile strength was measured according to ASTM D882-09. The separator was cut into a width of 10 mm and a length≥150 mm and stretched with universal tensile machine at a rate of 500 mm/min to obtain the maximum load value at the sample break. The maximum load value was divided by the cross-sectional area (sample width×substrate thickness) to determine the tensile strength of the separator.

Measurement of Peeling Force

A 20 mm wide standard tape (31B, available from Nitto Denko) was adhered to the ceramic layer of the separator by a roller press at a fixed stress (2 kg, 300 mm/min), and a tensile tester was used to perform 180-degree peeling test at a speed of 300 mm/min, and a 50-point peeling force value was taken at a test distance of 50 mm to 120 mm and an average value was calculated.

Measurement of Wettability

The separator was cut into a size of 50 mm×50 mm, and 1 ml of a standard electrolyte (1 M of LiPF6 was dissolved in the solution of ethylene carbonate (EC), methyl ethyl carbonate (EMC), and dimethyl carbonate (DMC) in a weight ratio of 1:1:1) was dripped onto the sample, and the distance of diffusion of the electrolyte was recorded after 3 minutes.

Measurement of Liquid Absorption Rate

The separator was cut into a size of 200 mm×15 mm, and the sample was hung vertically in an enclosed space to soak the solution of EC, EMC, and DMC in a weight ratio of 1:1:1, and the height of capillary absorption of the separator was recorded after 15 minutes, and the liquid absorption rate was calculated.

Measurement of Discharge Performance at Different C Rates

A button-type battery was used for the discharge performance at different C rates test. The positive electrode of the battery was lithium metal, the negative electrode was graphite, and the electrolyte was standard electrolyte (1 M of LiPF6 was dissolved in the solution of EC, EMC, and DMC in a weight ratio of 1:1:1).

Charging conditions: The battery was charged at a constant current-constant voltage mode (CC-CV mode) at room temperature. First charge in constant current mode with a fixed current of 0.5 C until the voltage rose to 0.05 V, then switch to constant voltage mode and charge the battery voltage to 4.3 V to fully charge the battery. When the battery was fully charged, the cut-off current was 0.02 C.

Discharge conditions: Discharge in constant current mode to 1.5 V at different discharge rates (C rate: 0.2 C/0.5 C/1 C/2 C/3 C).

First take the discharge capacity measured at 0.2 C in constant current mode as the standard capacity (discharge rate=100%), then record the discharge capacity at 0.5 C/1 C/2 C/3 C in constant current mode, and then divide its discharge capacity by the standard capacity to get the discharge performance at different C rates, and express it as a percentage.

TABLE 1

| | Example. | Example. | Example. | Comparative |
|---|---|---|---|---|
| Property | 1 | 2 | 3 | Example |
| Gurley | 369.3 | 372.2 | 370.7 | 364.9 |
| (sec/100 c.c.) | | | | |
| Tensile Strength | 180.5 | 176.7 | 179.9 | 178.5 |
| (kgf/cm²) | | | | |
| Peeling Force | 13 | — | — | 10.5 |
| (kgf) | | | | |
| Wettability | 4 | 5 | 6 | 2 |
| (mm/3 min) | | | | |
| Liquid | 12 | 12.25 | 12.5 | 9 |
| Absorption Rate | | | | |
| (mm/15 min) | | | | |

As shown in Table 1, the Gurley and tensile strength of the ceramic separators of Examples 1 to 3 and Comparative Examples had no significant difference, from this, it can be seen that the ceramic layers comprising polydopamine-surface-decorated inorganic particles did not substantially affect the Gurley and tensile strength of the ceramic separators. The adhesion of the ceramic layer of Example 1 was significantly improved by comprising the polydopamine-surface-decorated inorganic particles. The affinity for the electrolyte of the separators of Examples 1 to 3 was increased thereby increasing the wettability and liquid absorption rate because the ceramic layer comprised polydopamine-surface-decorated inorganic particles.

TABLE 2

| Property/ | | Example. | Comparative |
|---|---|---|---|
| C rate | | 1 | Example |
| Discharge | 0.2 C | 100 | 100 |
| Performance | 0.5 C | 99.3 | 99.5 |
| (%) | 1 C | 97.5 | 97.5 |
| | 2 C | 92.3 | 90.7 |
| | 3 C | 86.5 | 82.1 |

As shown in Table 2, the discharge performance of the ceramic separator of Example 1 at different C rates was better than that of Comparative Example 1.

After coating the inorganic particles that were surface-decorated with polydopamine aqueous solution in the present invention, the surface of the ceramic separator can quickly absorb the electrolyte. When this ceramic separator is applied to a lithium battery, the internal resistance and ionic conductivity of the battery can be effectively improved, so that the battery's discharge capacity can be improved. In addition, in the process of assembling lithium batteries, the time required for the separator to absorb the electrolyte can also be shortened, thereby increasing production speed.

Moreover, through the manufacturing method of the ceramic separator of the present invention, polydopamine is first prepared and then used for the surface decoration of the inorganic particles, so that the dopamine monomer does not need to be polymerized during the production of the separator, and continuous and rapid production and winding can be performed. Through the manufacturing method of the present invention, the obtained ceramic composite slurry can be directly used in a general coating process, so there is no need to purchase additional equipment.

Although particular embodiments have been shown and described, it should be understood that the above discussion is not intended to limit the present invention to these embodiments. Persons skilled in the art will understand that various changes and modifications may be made without departing from the scope of the present invention as literally and equivalently covered by the following claims.

What is claimed is:

1. A ceramic separator, comprising:
a porous polypolyolefin substrate; and
a ceramic layer coated on at least one surface of the porous polyolefin substrate,
wherein the ceramic layer comprises polydopamine-surface-decorated inorganic particles and a water-based binder, and the polydopamine-surface-decorated inorganic particles are surface-decorated with 0.06 to 1.2 parts by weight of polydopamine relative to 100 parts by weight of inorganic particles.

2. The ceramic separator as claimed in claim 1, wherein the porous polyolefin substrate is a single-layer or a multi-layer membrane of polyethylene or polypropylene, or a composite multi-layer membrane of polyethylene and polypropylene.

3. The ceramic separator as claimed in claim 1, wherein the polydopamine-surface-decorated inorganic particles are surface-decorated with 0.12 to 0.96 parts by weight of polydopamine relative to 100 parts by weight of inorganic particles.

4. The ceramic separator as claimed in claim 1, wherein the inorganic particles are at least one selected from the group consisting of Mg(OH)₂, BaSO₄, BaTiO₃, Pb(Zr,Ti)O₃ (PZT), Pb₁₋ₓLaₓZr_{1-y}, Zr, Ti_{y}O₃ (PLZT, wherein 0<x<1 and 0<y<1), Pb(Mg_{1/3}Nb_{2/3})O₃—PbTiO₃ (PMN-PT), HfO₂, SrTiO₃, SnO₂, CeO₂, MgO, NiO, CaO, ZnO, ZrO₂, SiO₂, Y₂O₃, Al₂O₃, Boehmite (AlOOH), SiC, TiO₂, and the combination thereof.

5. The ceramic separator as claimed in claim 1, wherein the median diameter (D₅₀) of the inorganic particles is in the range between 0.1 μm and 10 μm, and the specific surface area of the inorganic particles is in the range between 2 m²/g and 100 m²/g.

6. The ceramic separator as claimed in claim 1, wherein the water-based binder is at least one selected from the group consisting of styrene butadiene rubber, polyethyl acrylate, polybutyl methacrylate, and the combination thereof.

7. The ceramic separator as claimed in claim 1, wherein the thickness of the ceramic layer of the ceramic separator is in the range between 1 μm and 25 μm.

8. The ceramic separator as claimed in claim 1, wherein the ceramic layer comprises 80 to 99 parts by weight of polydopamine-surface-decorated inorganic particles and 1 part by weight to 20 parts by weight of water-based binder.

9. The ceramic separator as claimed in claim 8, wherein the ceramic layer comprises 85 to 95 parts by weight of polydopamine-surface-decorated inorganic particles and 5 to 15 parts by weight of water-based binder.

10. A method for manufacturing a ceramic separator, comprising:
providing a polydopamine solution;
adding a plurality of inorganic particles to the polydopamine solution to form an polydopamine-surface-decorated inorganic particles slurry;
providing a water-based binder solution;
mixing the polydopamine-surface-decorated inorganic particles slurry with the water-based binder solution to form a ceramic composite slurry; and
coating the ceramic composite slurry on a porous polyolefin substrate to form a ceramic separator with a ceramic layer.

11. The method for manufacturing a ceramic separator as claimed in claim 10, wherein the polydopamine solution is obtained by polymerizing dopamine in an alkaline environment, and the concentration of the polydopamine solution is between 500 ppm and 10,000 ppm.

12. The method for manufacturing a ceramic separator as claimed in claim 11, wherein the concentration of the polydopamine solution is between 1,000 ppm and 8,000 ppm.
